(19) United States
(12) Patent Application Publication
(10) Pub. No.: US 2008/0294342 A1
(43) Pub. Date: Nov. 27, 2008

(54) Position Detecting Device And Position Detecting Method

(76) Inventors: Takayuki Hoshizaki, Torrance, CA (US); Takayuki Watanabe, Iwaki-city (JP)

Correspondence Address: ALPINE/BHGL, P.O. Box 10395, Chicago, IL, 60610, US

(21) Appl. No.: 12/030,654

(22) Filed: Feb. 13, 2008

(30) Foreign Application Priority Data
Mar. 1, 2007 (JP) 2007-051152

(51) Int. Cl. G01C 21/16

(52) U.S. Cl. 701/216

(57) ABSTRACT

A dead reckoning unit calculates vehicle position from a pitch angle and a yaw angle of dead reckoning sensors, a sensor installation pitch angle and a sensor installation yaw angle, and a moving distance calculated by a speed sensor, and calculates vehicle speed from an acceleration signal. On a first cycle, a first correction unit calculates the vehicle speed from signals output from the speed sensor, and corrects the pitch angle, the sensor installation pitch angle, and the sensor installation yaw angle, based on the difference between the thus calculated vehicle speed and the vehicle speed calculated by the dead reckoning unit. On a second cycle, a second correction unit corrects the pitch angle, the sensor installation pitch angle, the yaw angle, and the sensor installation yaw angle, by using vehicle position and speed output from a GPS receiver and vehicle position and speed output from the dead reckoning unit.

### RELATED APPLICATIONS

The present application claims priority to Japanese Patent Application Number 2007-051152, filed Mar. 1, 2007, the entirety of which is hereby incorporated by reference.

### BACKGROUND OF THE INVENTION

1. Field of the Invention

The present invention relates to a position detecting device and a position detecting method for detecting a current position of a vehicle, and particularly to a position detecting device and a position detecting method capable of improving the accuracy of positional data calculated by dead reckoning (autonomous navigation) when GPS (Global Positioning System) reception is unavailable.

2. Description of Related Art

An on-vehicle navigation device employs, in combination, dead reckoning using a dead reckoning sensor and GPS navigation using a GPS receiver.

Dead reckoning is a method of detecting, for example, the position, the direction, and the speed of a vehicle by using outputs from an acceleration sensor which detects the acceleration of the vehicle, a relative direction sensor which detects the amount of change in the direction of the vehicle (e.g., a gyroscope, which is hereinafter referred to as a gyro), and a distance sensor which detects the speed (the distance over time) of the vehicle (e.g., a vehicle speed sensor). However, the outputs (e.g., the position, the direction, and the vehicle speed) obtained by the dead reckoning process include errors of the sensors. Therefore, errors occur in the results of performing dead reckoning. Particularly, the position and the direction are calculated by adding up the outputs from the sensors. Thus, the errors are gradually accumulated. Meanwhile, the absolute position, direction, and vehicle speed can be obtained by using GPS with a maximum position error of approximately 30 meters in a normal environment. When GPS reception is available, therefore, if the outputs obtained by dead reckoning are adjusted to the outputs obtained by GPS, the errors occurring through accumulation can be corrected. For example, if a predetermined value is exceeded by the difference between the position of a vehicle obtained by dead reckoning and corrected to a road position on a road map by a commonly known map matching method and the position obtained by GPS, the position on the road map is corrected to the position obtained by GPS.

Dead reckoning can be corrected by the outputs from GPS, as described above. When GPS reception is unavailable, however, the errors occurring in dead reckoning are accumulated due to the errors of the outputs from the sensors and installation errors, and the accuracy of the outputs deteriorates. Particularly, GPS signals do not reach inside a multistory parking lot or a basement parking lot. Thus, a maximum position error of approximately 100 meters can occur. Further, reflected GPS signals are often received in an inner-city area. Thus, if multipath reception occurs, a maximum position error of approximately 300 meters can occur.

In view of the above circumstances, methods for obtaining a current position by correcting the errors of the outputs from the sensors have been proposed. According to Japanese Unexamined Patent Application Publication No. 8-68655 (hereinafter referred to as the first conventional technique), on the basis of information about the position, the direction, and the speed of a vehicle obtained by dead reckoning and information about the position, the direction, and the speed of the vehicle output from UPS, an offset error, a distance factor error, an absolute direction error, and an absolute position error are calculated by a Kalman filter, and the respective errors occurring in the dead reckoning process are corrected.

Japanese Unexamined Patent Application Publication No. 2003-75172 (hereinafter referred to as the second conventional technique) includes an acceleration sensor for outputting an acceleration signal in accordance with the acceleration in the longitudinal direction of a vehicle, a distance sensor for outputting a distance signal in accordance with the moving distance of the vehicle, and a Kalman filter unit. The Kalman filter unit performs a Kalman filter process on the basis of the acceleration signal and the distance signal to calculate the speed and the attitude angle of the vehicle (the pitch angle of the vehicle with respect to a horizontal surface) at each discrete time. Then, using the attitude angle, the position error occurring during driving on a slope is corrected.

The first conventional technique is for correcting the offset error, the distance factor error, the absolute direction error, and the absolute position error occurring in dead reckoning, when GPS reception is available. The positioning cycle of GPS is one second (1 Hz). Thus, the above correction is performed every one second. However, the correction cycle is too long to perform sufficient correction. As a result, highly accurate position detection cannot be performed. Further, the first conventional technique uses four parameters of a two-dimensional position and a two-dimensional speed. Thus, the technique cannot correct the pitch angle of the vehicle and installation angles of the dead reckoning sensors with respect to the vehicle (an installation pitch angle and an installation yaw angle of the sensors with respect to the vehicle).

According to the second conventional technique, the attitude angle of the vehicle (the pitch angle of the vehicle with respect to a horizontal surface) and the speed in the longitudinal direction of the vehicle are calculated at each discrete time by using three-dimensional speed parameters. Then, using the attitude angle, the position error occurring during driving on a slope is corrected. Further, according to the second conventional technique, the position error including the height is corrected by using three-dimensional position data of GPS. However, in the former correction of the second conventional technique, the three-dimensional position data of GPS is not used in the correction of the position error. Thus, the errors are accumulated to reduce the accuracy of the position. Further, in the latter correction of the second conventional technique, the correction is performed on the cycle in which the position information can be obtained from GPS (every one second). Thus, the correction cycle is too long to perform sufficient correction, and highly accurate position detection cannot be performed. Furthermore, according to the second conventional technique, the installation yaw angle of the dead reckoning sensors cannot be corrected.

### SUMMARY OF THE INVENTION

In view of the above circumstances, an object of the present invention is to enable highly accurate position detection by performing a first correction process on a shorter cycle than a positioning cycle of GPS and by performing a second correction process on the positioning cycle of GPS (every one second) with the use of GPS data.

Another object of the present invention is to improve the accuracy of position detection by correcting, in the first correction process, a vehicle pitch angle and an installation pitch angle of dead reckoning sensors with respect to a vehicle and by calculating the speed and the position of the vehicle with the use of the corrected parameters.

Another object of the present invention is to improve the accuracy of position detection by correcting, in the second correction process, a pitch angle θ, a sensor installation pitch angle A, a yaw angle Y, and a sensor installation yaw angle A2 with the use of a vehicle position in the latitudinal direction, the longitudinal direction, and the height direction and a vehicle speed in the latitudinal direction, the longitudinal direction, and the height direction obtained by GPS and by calculating the speed and the position of the vehicle with the use of the corrected parameters.

An object of the present invention is to improve the accuracy of position detection by correcting offset values of an acceleration sensor and a relative direction sensor.

One embodiment of the present invention is a position detecting device for detecting a current position of a vehicle. The position detecting device includes a moving distance detection unit, an acceleration sensor, a relative direction sensor, a GPS receiver, a dead reckoning unit, a first correction unit, and a second correction unit. The moving distance detection unit measures the moving distance of the vehicle. The acceleration sensor detects the acceleration of the vehicle. The relative direction sensor outputs a signal in accordance with the amount of change in the direction of the vehicle. The GPS receiver receives satellite radio waves from a GPS satellite, and outputs information of a vehicle position and a vehicle speed in the latitudinal direction, the longitudinal direction, and the height direction. On a first cycle, the dead reckoning unit calculates the vehicle position in the latitudinal direction, the longitudinal direction, and the height direction by using a pitch angle θ with respect to a horizontal surface and a yaw angle Y of the sensors for dead reckoning, a sensor installation pitch angle A and a sensor installation yaw angle A2 with respect to the vehicle, and the moving distance, and calculates the vehicle speed by using an acceleration signal output from the acceleration sensor. On a second cycle longer than the first cycle, the first correction unit calculates the vehicle speed by using a signal output from the moving distance detection unit, and corrects, on the basis of the difference in speed between the thus calculated vehicle speed and the vehicle speed calculated by the dead reckoning unit, the vehicle speed, the pitch angle θ, the sensor installation pitch angle A, and the sensor installation yaw angle A2 calculated by the dead reckoning unit. On a third cycle longer than the second cycle, the second correction unit corrects the vehicle position in the latitudinal direction, the longitudinal direction, and the height direction, the vehicle speed, the pitch angle θ, the sensor installation pitch angle A, the yaw angle Y, the sensor installation yaw angle A2, an angular speed signal offset, and an acceleration signal offset calculated by the dead reckoning unit, by using the vehicle position and the vehicle speed in the latitudinal direction, the longitudinal direction, and the height direction output from the GPS receiver and the vehicle position and the vehicle speed in the latitudinal direction, the longitudinal direction, and the height direction output from the dead reckoning unit.

The position detecting device described above may include an offset correction unit which, on the basis of the difference between an angular speed signal output from the relative direction sensor and the angular speed signal offset calculated by the dead reckoning unit, corrects the offset of the angular speed signal on the second cycle, when the vehicle is in a stopped state. Then, a value obtained by subtracting the angular speed signal offset from the angular speed signal may be used as a true angular speed signal.

In the position detecting device described above, the first correction unit may correct the angular speed signal offset and the acceleration signal offset in every correction of the vehicle speed calculated by the dead reckoning unit. Further, the dead reckoning unit may calculate the vehicle position in the latitudinal direction, the longitudinal direction, and the height direction, the vehicle speed, the pitch angle θ, and the yaw angle Y by using a signal obtained by subtracting the acceleration signal offset from the acceleration signal output from the acceleration sensor as a true acceleration signal, and by using a signal obtained by subtracting the angular speed signal offset from the signal output from the relative direction sensor as a true angular speed signal.

A second embodiment of the present invention is a position detecting method for detecting a current position of a vehicle. The position detecting method includes first to third steps. At the first step, in a dead reckoning unit, and on a first cycle, a vehicle position in the latitudinal direction, the longitudinal direction, and the height direction is calculated by using a pitch angle θ with respect to a horizontal surface and a yaw angle Y of dead reckoning sensors, which output signals in accordance with the acceleration of the vehicle and the amount of change in the direction of the vehicle, a sensor installation pitch angle A and a sensor installation yaw angle A2 with respect to the vehicle, and a moving distance of the vehicle detected by a moving distance detection unit, and a vehicle speed is calculated by using an acceleration signal output from one of the sensors. At the second step, on a second cycle longer than the first cycle, the vehicle speed is calculated by using a signal output from the moving distance detection unit, and on the basis of the difference in speed between the thus calculated vehicle speed and the vehicle speed calculated by the dead reckoning unit, the vehicle speed, the pitch angle θ, the sensor installation pitch angle A, and the sensor installation yaw angle A2 calculated by the dead reckoning unit are corrected. At the third step, on a third cycle longer than the second cycle, the vehicle position in the latitudinal direction, the longitudinal direction, and the height direction, the vehicle speed, the pitch angle θ, the sensor installation pitch angle A, the yaw angle Y, the sensor installation yaw angle A2, an angular speed signal offset, and an acceleration signal offset calculated by the dead reckoning unit are corrected by using a vehicle position and a vehicle speed in the latitudinal direction, the longitudinal direction, and the height direction output from a GPS receiver and the vehicle position and the vehicle speed in the latitudinal direction, the longitudinal direction, and the height direction output from the dead reckoning unit.

The position detecting method described above may further include a step of, on the basis of the difference between an angular speed signal output from a relative direction sensor of the sensors and the angular speed signal offset calculated by the dead reckoning unit, correcting the offset of the angular speed signal on the second cycle, when the vehicle is in a stopped state.

The position detecting method described above may further include a step of correcting the angular speed signal offset and the acceleration signal offset in every correction of the vehicle speed in the dead reckoning unit, and a step of, in the dead reckoning unit, calculating the vehicle position in the latitudinal direction, the longitudinal direction, and the height direction, the vehicle speed, the pitch angle θ, and the yaw angle Y by using a signal obtained by subtracting the acceleration signal offset from an acceleration signal output from an acceleration sensor of the sensors as a true acceleration signal, and by using a signal obtained by subtracting the angular speed signal offset from an angular speed signal output from a relative direction sensor of the sensors as a true angular speed signal.

According to the present invention, the first correction process is performed on a shorter cycle than the positioning cycle of GPS, and the second correction process is performed on the positioning cycle of GPS (every one second) with the use of the GPS data. Accordingly, highly accurate position detection can be performed.

Further, according to the present invention, the pitch angle θ the sensor installation pitch angle A, and the sensor installation yaw angle A2 are corrected through the correction process by using the vehicle speed calculated with the use of the estimated pitch angle and the acceleration signal obtained from the acceleration sensor and the vehicle speed calculated from the vehicle pulses. Further, the speed and the position of the vehicle are calculated by using the above parameters. Accordingly, the accuracy of position detection can be improved.

Further, according to the present invention, in the stopped state of the vehicle, the offset of the output from the gyro is measured and corrected, and the offset of the output from the accelerometer is also corrected. Accordingly, the accuracy of position detection can be improved.

Further, according to the present invention, the pitch angle θ, the sensor installation pitch angle A, the yaw angle Y, and the sensor installation yaw angle A2 are corrected in the second correction process by using the vehicle position in the latitudinal direction, the longitudinal direction, and the height direction and the vehicle speed in the latitudinal direction, the longitudinal direction, and the height direction obtained by GPS. Further, the speed and the position of the vehicle are calculated by using the above parameters. Accordingly, the accuracy of position detection can be improved.

### BRIEF DESCRIPTION OF THE DRAWINGS

FIG. 1 is a block diagram of a position detecting device according to an embodiment of the present invention;

FIGS. 2A and 2B are explanatory diagrams of attitude parameters (a pitch angle, a sensor installation pitch angle, a yaw angle, and a sensor installation yaw angle);

FIGS. 3A to 3C are explanatory diagrams of a method of calculating a vehicle speed by using an acceleration signal output from an acceleration sensor;

FIG. 4 illustrates an overall process flow performed by the position detecting device according to the embodiment of the present invention;

FIGS. 5A and 5B are explanatory diagrams of position detection errors occurring in the embodiment of the present invention, with FIG. 5A illustrating position detection errors occurring when GPS reception is available, and FIG. 5B illustrating position detection errors occurring when GPS reception is unavailable;

FIGS. 6A and 6B are explanatory diagrams of driving tracks of a vehicle exiting from a multistory parking lot of the Metropolitan Government Building, in which GPS reception is unavailable, after having driven around in the parking lot;

FIG. 7 is an enlarged view of a driving track in an underground multistory parking lot obtained by a navigation system including the position detecting device according to the embodiment of the present invention;

FIG. 8 is a diagram of an outline of a Kalman filter process;

FIG. 9 illustrates an example of a matrix representing a linear system of a Kalman filter; and

FIG. 10 illustrates an example of an observation matrix of the Kalman filter.

### DETAILED DESCRIPTION OF THE PREFERRED EMBODIMENTS

(A) Configuration of a Position Detecting Device According to an Embodiment of the Present Invention:

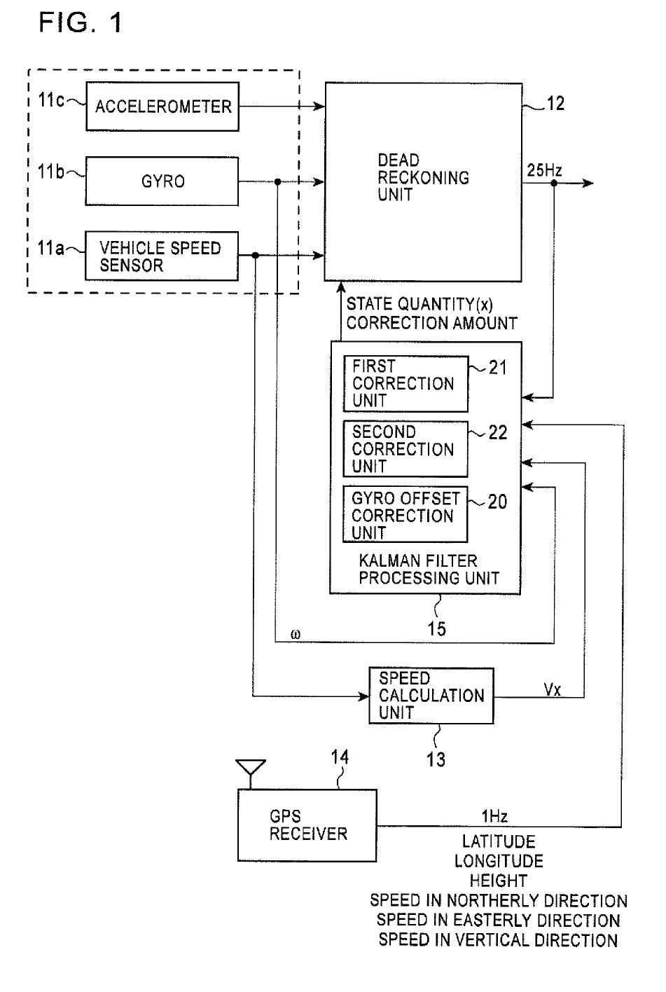

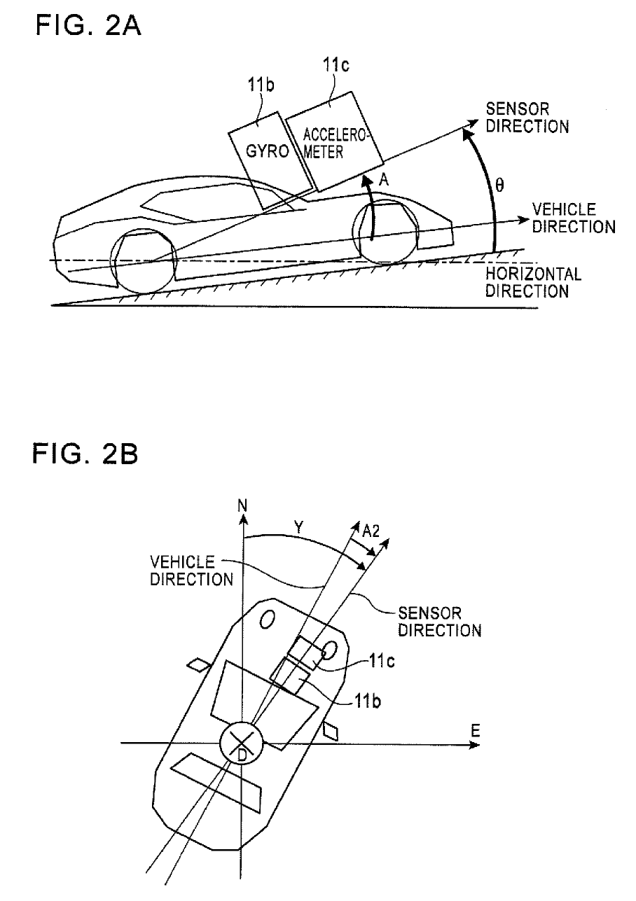

FIG. 1 is a block diagram of a position detecting device according to an embodiment of the present invention. The position detecting device can be used in position detection by a navigation device. The present position detecting device includes, as dead reckoning sensors, a moving distance detection unit for measuring the moving distance of a vehicle, such as a vehicle speed sensor 11a which generates one pulse every time the vehicle moves by a predetermined distance, for example; a gyro 11b which constitutes a relative direction sensor for outputting a signal in accordance with the amount of change in the direction of the vehicle; and an acceleration sensor 11c which detects the acceleration of the vehicle. The vehicle speed sensor 11a is installed on a wheel, while the gyro 11b and the acceleration sensor 11c are integrally mounted on a dashboard at a predetermined position. Ideally, the gyro 11b and the acceleration sensor 11c are installed in the vehicle to be parallel to the direction of the vehicle, as viewed from a lateral side. However, there may be an installation error, as illustrated in FIG. 2A. Thus, the gyro 11b and the acceleration sensor 11c are installed with an angle A (an installation pitch angle) formed between the direction of the sensors and the direction of the vehicle. An angle θ formed between the horizontal direction and the direction of the sensors is referred to as a pitch angle, which is the sum of the installation pitch angle and the angle of a slope. Further, the gyro 11b and the acceleration sensor 11c ideally, are installed in the vehicle to be aligned with the direction of the vehicle, when projected onto a plane. However, there may be an installation error. Thus, the gyro 11b and the acceleration sensor 11c are installed with an angle A2 (an installation yaw angle) formed between the direction of the sensors and the direction of the vehicle, as illustrated in FIG. 2B. An angle Y formed between the northerly direction and the direction of the sensors is referred to as a yaw angle. The yaw angle Y is the sum of the installation yaw angle and the angle formed between the northerly direction and the direction of the vehicle.

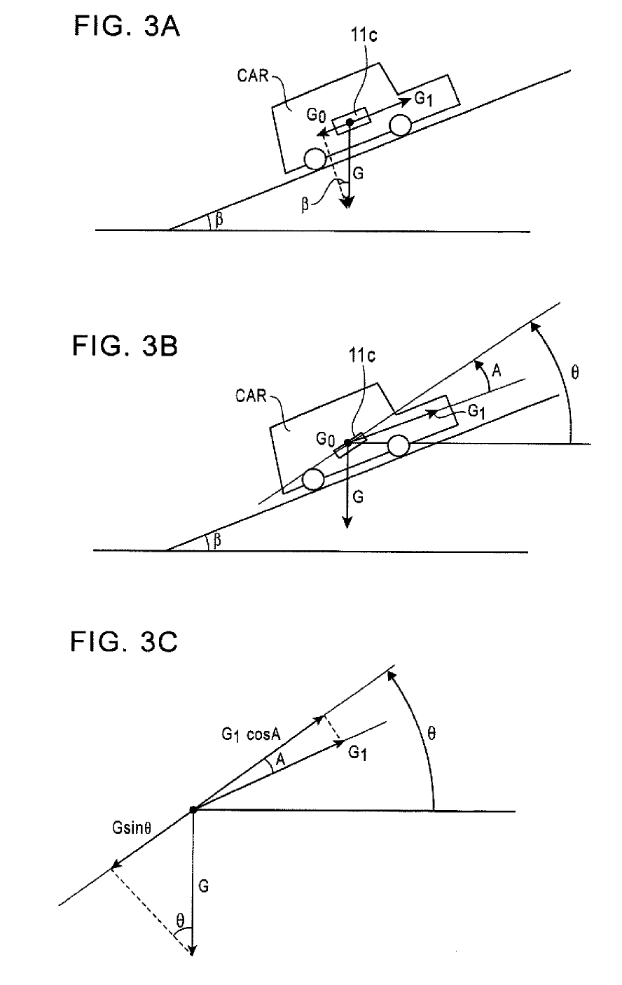

Using signals produced by the respective dead reckoning sensors, and at a high speed, e.g., on a cycle of 25 Hz, a dead reckoning unit 12 calculates a vehicle speed Vsp(k) in the longitudinal direction and a three-dimensional position (a distance N(k) in the latitudinal direction, a distance E(k) in the longitudinal direction, and a height D(k)) of the vehicle, and outputs the calculated values. FIGS. 3A to 3C are explanatory diagrams of a method of calculating the vehicle speed Vsp(k) by using an acceleration signal output from the acceleration sensor 11c. A vehicle CAR is subject to a gravitational acceleration G acting in the vertical direction. If the installation pitch angle A is zero, a component G₀ of the gravitational acceleration G acting in the direction of a slope is expressed as G₀=G×sin β, as illustrated in FIG. 3A. Therefore, an acceleration Acc measured by the acceleration sensor 11c is the sum of an acceleration G₁ acting in the moving direction of the vehicle along with the movement of the vehicle and the component G₀ of gravity acting in the direction of the slope. The acceleration Ace can be expressed as Acc=G×sin β+G₁. If the installation pitch angle A is not zero, the acceleration sensor 11c measures the acceleration Acc acting in the direction of the pitch angle θ(=β+A), as illustrated in FIG. 3B. Therefore, as illustrated in FIG. 3C, a gravitational acceleration component acting in the direction of the pitch angle θ is expressed as G×sin θ, and an acceleration component acting in the direction of the pitch angle θ along with the movement of the vehicle is expressed as G₁×cos A. Thus, an equation Acc=G×sin θ+G₁×cos A×cos A2 is established. Accordingly, the acceleration G₁ acting in the direction of the slope can be expressed by the following equation.

G₁=(Acc−G×sin θ)/(cos A×cos A2) (1)

Therefore, when T1 represents an acceleration measurement cycle, a speed of change ΔV is calculated from an equation ΔV=T1×(Acc−G×sin θ)/(cos A×cos A2). Accordingly, a speed Vsp(k+1) is calculated from the following equation by using ΔV and the speed Vsp(k) obtained at an immediately preceding discrete time k.

Vsp(k+1)=Vsp(k)+T1×(Acc−G×sin θ)/(cos A×cos A2) (2)

When α_{OF} represents the offset of the acceleration Acc, the calculation of the equation (2) is performed by using a value obtained by subtracting α_{OF} from the signal Acc output from the acceleration sensor 11c as Acc. That is, an equation Acc=Acc−α_{OF} is established.

The dead reckoning unit 12 further calculates a three-dimensional position (a distance N(k+1) in the latitudinal direction, a distance E(k+1) in the longitudinal direction, and a height D(k+1)) of the vehicle from the following equations, and outputs the calculated values.

N(k+1)=N(k)+S(cos θ cos Y cos A cos A2+sin Y sin A2+sin θ cos Y sin A cos A2)

E(k+1)=E(k)+S(cos θ sin Y cos A cos A2−cos Y sin A2+sin θ sin Y sin A cos A2)

D(k+1)=D(k)+S(−sin θ cos A cos A2+cos θ sin A cos A2) (3)

In the above equations, S represents the distance by which the vehicle moves in the direction of the vehicle in a sample time T1. The distance S is obtained by multiplying the number of vehicle speed pulses per sample time T1 by the distance between the pulses. With four angles (θ, A, Y, and A2), the distance S is projected onto an N-E-D coordinate system (a North-East-Down coordinate system).

A speed calculation unit 13 calculates the vehicle speed from the following equation by using the number of pulses N output from the vehicle speed sensor 11a on a predetermined cycle T2 (e.g., a cycle of 10 Hz) and a moving distance L per one pulse.

Vx=N×L/T2 (4)

A GPS receiver 14 calculates a three-dimensional position (the latitude, the longitude, and the height) and a three-dimensional speed (a speed in the northerly direction, a speed in the easterly direction, and a speed in the vertical direction) on the basis of signals received from a GPS satellite on a GPS positioning cycle, e.g., at intervals of one second, and outputs the calculated values.

A Kalman filter unit 15 includes a gyro offset correction unit 20, a first correction unit 21, and a second correction unit 22.

When the speed Vx is zero (i.e., during the stopped state of the vehicle), an angular speed signal ω obtained during the stopped state is the sum of the offset and noise. Using this fact, the gyro offset correction unit 20 calculates the difference between the output of the angular speed signal ω and an angular speed signal offset ω_{OF} calculated by the dead reckoning unit 12, and corrects the angular speed signal offset ω_{OF} in a short time through a later-described Kalman filter process.

The dead reckoning unit 12 calculates a change in direction Δω(k) from an equation Δω(k)=(ω−ω_{OF})×T1 by using the angular speed signal a? measured with the use of the signal output from the gyro 11b, and updates the pitch angle θ and the yaw angle Y on the basis of the following equations derived from a commonly known inertial navigation system technique.

c₀₀=cos θ(k+1)×cos Y(k+1)=−sin Y(k)×Δω(k)

c₁₀=cos θ(k+1)×sin Y(k+1)=cos Y(k)×Δω(k) (5)

The dead reckoning unit 12 maintains the sensor installation pitch angle A, the sensor installation yaw angle A2, the angular speed signal offset ω_{OF}, and the acceleration signal offset α_{OF} constant, until the above parameters are corrected by the following equations.

A(k+1)=A(k)

A2(k+1)=A2(k)

ω_{OF}(k+1)=ω_{OF}(k)

ω_{OF}(k+1)=α_{OF}(k) (6)

The first correction unit 21 of the Kalman filter unit 15 performs a first Kalman filter process on a first cycle (e.g., a cycle of 10 Hz). In the first Kalman filter process, on the basis of the difference between the vehicle speed Vx calculated by the speed calculation unit 13 and the vehicle speed Vsp calculated by the dead reckoning unit 12, the first correction unit 21 corrects the vehicle speed Vsp, the pitch angle θ, the sensor installation pitch angle A, the sensor installation yaw angle A2, the angular speed signal offset ω_{OF}, and the acceleration signal offset α_{OF}, which are calculated by the dead reckoning unit 12.

Using the three-dimensional vehicle position and the three-dimensional vehicle speed output from the GPS receiver 14 and the three-dimensional vehicle position and the three-dimensional vehicle speed output from the dead reckoning unit 12, the second correction unit 22 of the Kalman filter unit 15 corrects, on a second cycle longer than the first cycle (e.g., a cycle of 1 Hz), the vehicle position in the latitudinal direction, the longitudinal direction, and the height direction, the vehicle speed, the pitch angle θ, the sensor installation pitch angle A, the yaw angle Y, the sensor installation yaw angle A2, the angular speed signal offset ω_{OF}, and the acceleration signal offset α_{OF}, which are calculated by the dead reckoning unit 12 (all parameters calculated by dead reckoning). Details of the Kalman filter process performed by the first and second correction units 21 and 22 will be described later.

Using the pitch angle θ, the sensor installation pitch angle A, and the sensor installation yaw angle A2 updated by the first correction unit 21 on the cycle of 10 Hz, the dead reckoning unit 12 calculates the vehicle speed and the vehicle position from the equations (2) and (3). Further, using the pitch angle θ, the sensor installation pitch angle A, the yaw angle Y, and the sensor installation yaw angle A2 updated by the second correction unit 22 on the cycle of 1 Hz, the dead reckoning unit 12 calculates the vehicle speed and the vehicle position from the equations (2) and (3). Then, the dead reckoning unit 12 outputs the calculated values.

(B) Operation of the Position Detecting Device According to the Embodiment of the Present Invention:

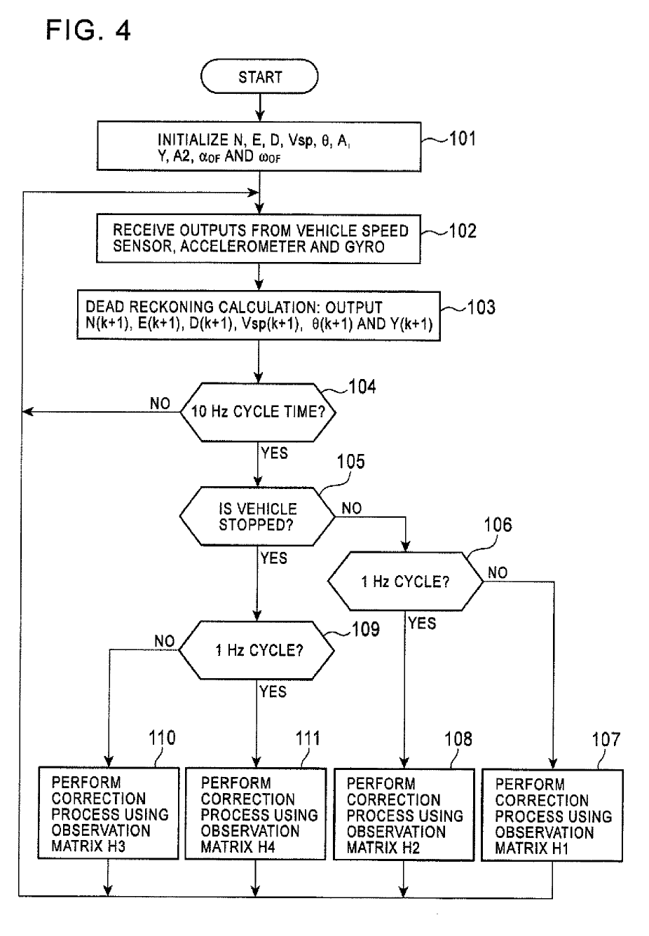

FIG. 4 illustrates an overall process flow performed by the position detecting device according to the embodiment of the present invention.

First, initial values of the elements of the three-dimensional vehicle position N, E, and D, the vehicle speed Vsp, the pitch angle θ, the sensor installation pitch angle A, the yaw angle Y, the sensor installation yaw angle A2, the angular speed signal offset ω_{OF} obtained from the gyro 11b, and the acceleration signal offset α_{OF} obtained from the acceleration sensor 11c are set in the dead reckoning unit 12 (Step S101). Thereafter, the dead reckoning unit 12 receives the outputs from the vehicle speed sensor 11a, the gyro 11b, and the acceleration sensor 11c (Step S102). Then, the dead reckoning unit 12 performs the calculations of equations (2), (3), and (5) on a first cycle (a cycle of 25 Hz) to calculate the vehicle speed Vsp(k+1), the three-dimensional position (the distance N(k+1) in the latitudinal direction, the distance E(k+1) in the longitudinal direction, and the height D(k+1)) of the vehicle, and two values relating to the pitch angle θ and the yaw angle Y, i.e., cos θ(k+1)×cos Y(k+1) and cos θ(k+1)×sin Y(k+1), and outputs the calculated values (Step S103). Then, whether or not the cycle has become a second cycle (a cycle of 10 Hz) is checked (Step S104). If the cycle has not become the second cycle, the processes of Step S102 and the subsequent steps are repeated.

If the cycle has become the second cycle, whether or not the vehicle is stopped is determined on the basis of whether or not the state in which the vehicle speed Vx is zero has lasted for at least two seconds (Step S105).

If the vehicle is not in the stopped state, whether or not the cycle has become a third cycle (a cycle of 1 Hz, which constitutes the GPS positioning cycle) is checked (Step S106). If the cycle has not become the third cycle, the first correction unit 21 of the Kalman filter unit 15 corrects through the Kalman filter process the vehicle speed, the pitch angle θ, the sensor installation pitch angle A, the sensor installment yaw angle A2, the angular speed signal offset ω_{OF}, and the acceleration signal offset α_{OF} by using the vehicle speed Vx calculated from equation (4) by the speed calculation unit 13 and the vehicle speed Vsp(k) calculated from equation (2) by the dead reckoning unit 12 (Step S107). At Step 107, a later-described first correction process by the Kalman filter is performed with the use of an observation matrix H1.

If the cycle has become the third cycle at step S106, the second correction unit 22 of the Kalman filter unit 15 corrects the vehicle position, the vehicle speed, the pitch angle θ, the sensor installation pitch angle A, the yaw angle Y, the sensor installation yaw angle A2, the angular speed signal offset ω_{OF}, and the acceleration signal offset α_{OF} by using a three-dimensional vehicle position (N_{GPS}, E_{GPS}, and D_{GPS}) and a three-dimensional vehicle speed (VN_{GPS}, VE_{GPS}, and VD_{GPS}) output from the GPS receiver 14 (Step S108). At step S108, a later-described second correction process by the Kalman filter is performed with the use of an observation matrix H2.

If the vehicle is in the stopped state at step S105, whether or not the cycle has become the third cycle (the cycle of 1 Hz, which is the GPS positioning cycle) is checked (Step S109). If the cycle has not become the third cycle, the first correction unit 21 of the Kalman filter unit 15 performs the correction process of step S107, and also performs correction of the angular speed signal offset ω_{OF} on the basis of the difference between the angular speed signal ω output from the gyro 11b and the angular speed signal offset ω_{OF} calculated by the dead reckoning unit 12 (Step S110). At step S110, a later-described third correction process by the Kalman filter is performed with the use of an observation matrix H3.

If the cycle has become the third cycle at step S109, the second correction unit 22 of the Kalman filter unit 15 performs the correction process of step S108, and also performs the correction of the angular speed signal offset ω_{OF} on the basis of the difference between the angular speed signal ω output from the gyro 11b and the angular speed signal offset ω_{OF} calculated by the dead reckoning unit 12 (Step S111). At step S111, a later-described fourth correction process by the Kalman filter is performed with the use of an observation matrix H4.

(C) Effects of the Embodiment of the Present Invention:

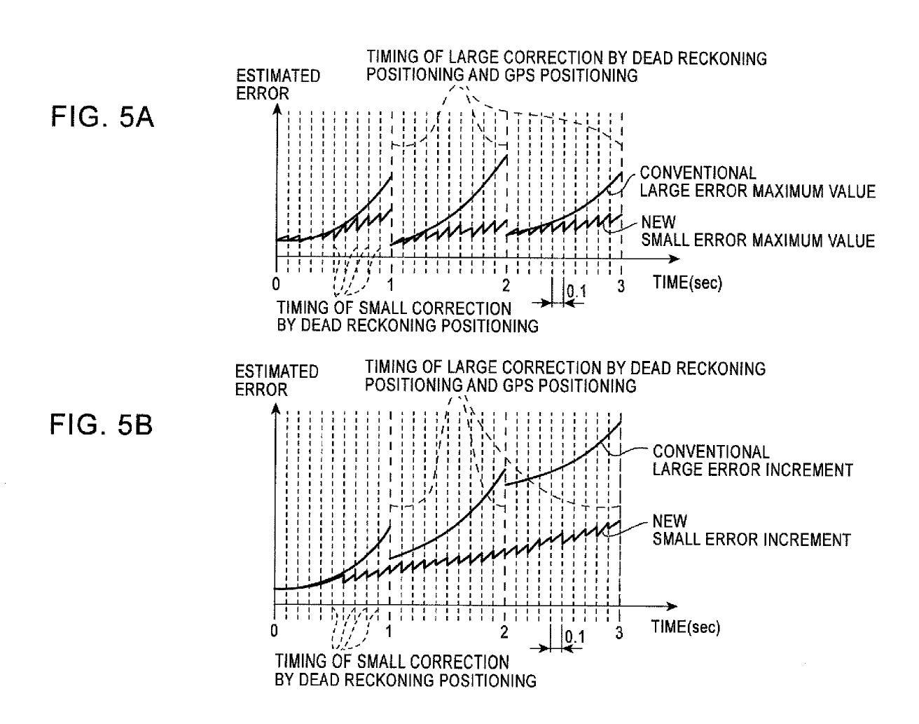

According to the embodiment of the present invention, the first correction unit 21 corrects the accumulated errors at a faster frequency than the frequency used in the correction of the estimated errors performed by GPS. Therefore, highly accurate position detection can be performed. FIGS. 5A and 5B are explanatory diagrams of position detection errors occurring in the embodiment of the present invention, with FIG. 5A illustrating position detection errors occurring when GPS reception is available, and FIG. 5B illustrating position detection errors occurring when GPS reception is unavailable. For comparison, the figure also illustrates position detection errors occurring in a conventional technique. According to the embodiment of the present invention, when GPS reception is available, the first correction unit 21 corrects the pitch angle, the sensor installation pitch angle, and the sensor installation yaw angle on the cycle of 10 Hz, while the second correction unit 22 performs the correction on the cycle of 1 Hz (the GPS positioning cycle). Therefore, the accumulation of the errors can be reduced. Meanwhile, according to the conventional technique in which the correction process is performed on the cycle of 1 Hz (the GPS positioning cycle) with the use of GPS positioning data, the accumulated errors are reset on the cycle of 1 Hz. However, the accumulated errors are increased during the cycle. Further, according to the embodiment of the present invention, the first correction unit 21 corrects the pitch angle, the sensor installation pitch angle, and the sensor installation yaw angle on the cycle of 10 Hz, even when GPS reception is unavailable. Therefore, the degree of accumulation of errors can be reduced. According to the conventional technique in which the correction process is performed by using only the GPS positioning data, however, the correction cannot be performed when the GPS reception is unavailable. Therefore, the degree of accumulation of errors is increased. As a result, the total errors are increased.

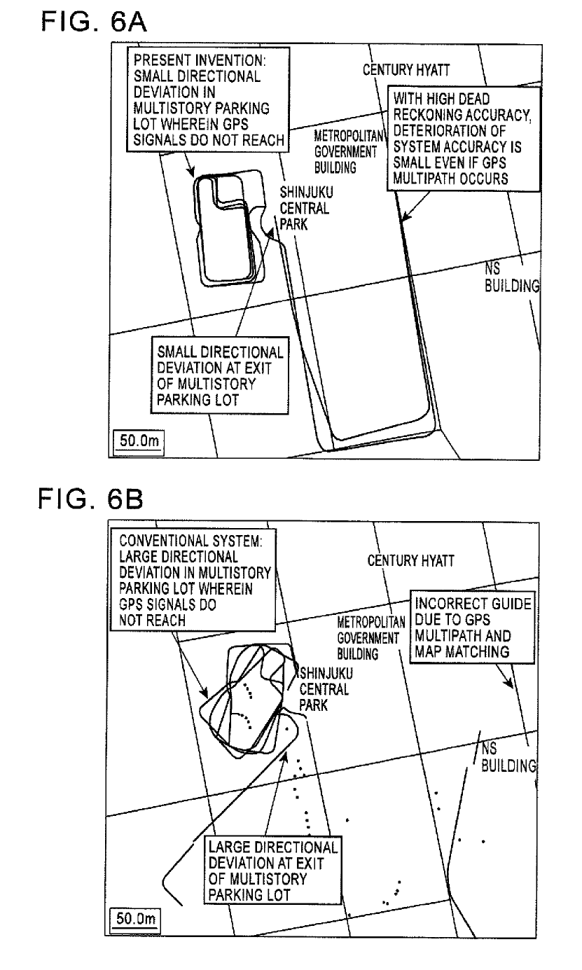

FIGS. 6a and 6B illustrate the driving tracks of a vehicle exiting from a multistory parking lot of the Metropolitan Government Building, in which GPS reception is unavailable, after having driven around in the parking lot. FIG. 6A illustrates a driving track obtained by applying the position detecting device according to the embodiment of the present invention to a navigation system. Meanwhile, FIG. 6B illustrates a driving track obtained by a conventional navigation system having a map matching function. According to the embodiment of the present invention, the directional deviation is small in the multistory parking lot, in which GPS signals do not reach, and the directional deviation is also small at an exit of the multistory parking lot. Further, the accuracy of the dead reckoning is high. Therefore, the deterioration in accuracy of the position is small even if GPS multipath occurs. According to the conventional technique, however, the directional deviation is large in the multistory parking lot, in which GPS signals do not reach, and the directional deviation is also large at an exit of the multistory parking lot. Further, if GPS multipath occurs, map matching to an incorrect road is caused.

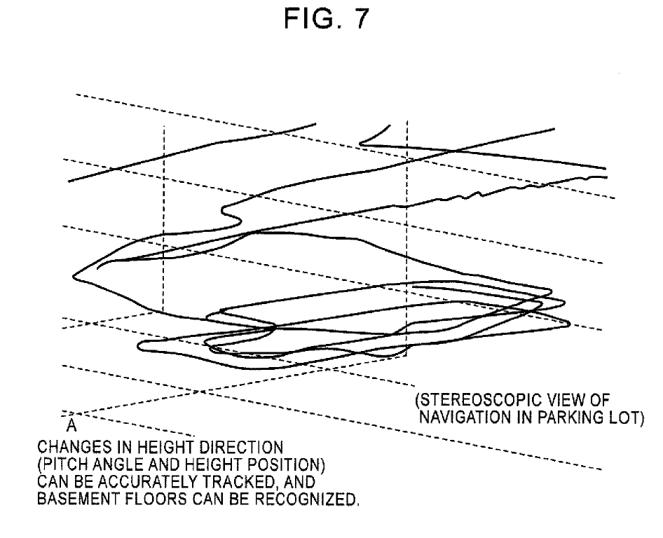

FIG. 7 is an enlarged view of a driving track in an underground multistory parking lot obtained by the navigation system which includes the position detecting device according to the embodiment of the present invention. As indicated by the reference character A, changes in the height direction (the pitch angle and the height position) can be accurately tracked. Accordingly, a basement floor can be recognized.

(D) Kalman Filter Process by an Embodiment of the Present Invention:

The Kalman filter process is a method of successively calculating an optimal estimated value at each time while correcting the error between a predicted value and an observed value at each time. In the Kalman filter process, a calculation formula for predicting a given value is set in advance, and prediction using the calculation formula is repeated until a time n at which the observed value is obtained. If the observed value can be obtained at the time n, the error of the observed value is subtracted. Thereafter, a calculation to correct the estimated value so as to minimize a stochastically defined error of the estimated value at the time n is performed.

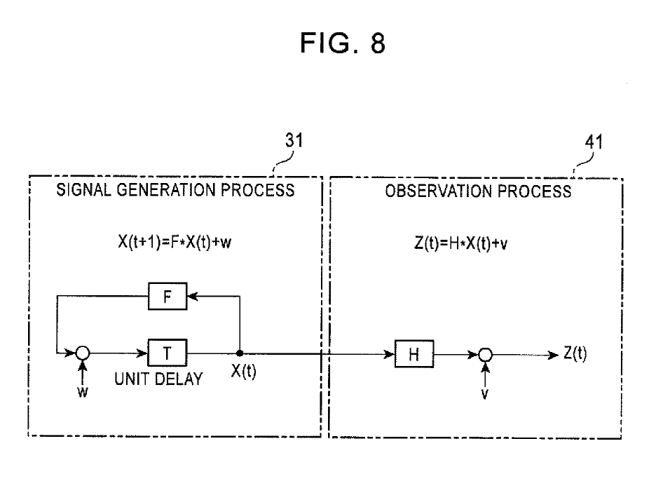

FIG. 8 is an outline of the Kalman filter process. As illustrated in FIG. 8, the Kalman filter process is divided into a signal generation process 31 and an observation process 41. The figure illustrates a linear system F, and X(t) represents the state of the system. When a part of X(t) can be observed via an observation matrix H, the filter provides an optimal estimated value of X(t). In this case, w and v represent noise generated in the signal generation process 31 and noise generated in the observation process 41, respectively. The Kalman filter calculates the optimal estimated value X(t) by repeatedly performing the Kalman filter process on a predetermined cycle with the input of Z(t).

A state equation of a system model in the Kalman filter process according to an embodiment of the present invention is expressed as the following equation.

δX(k+1)=F(k)δX(k)+w(k) (7)

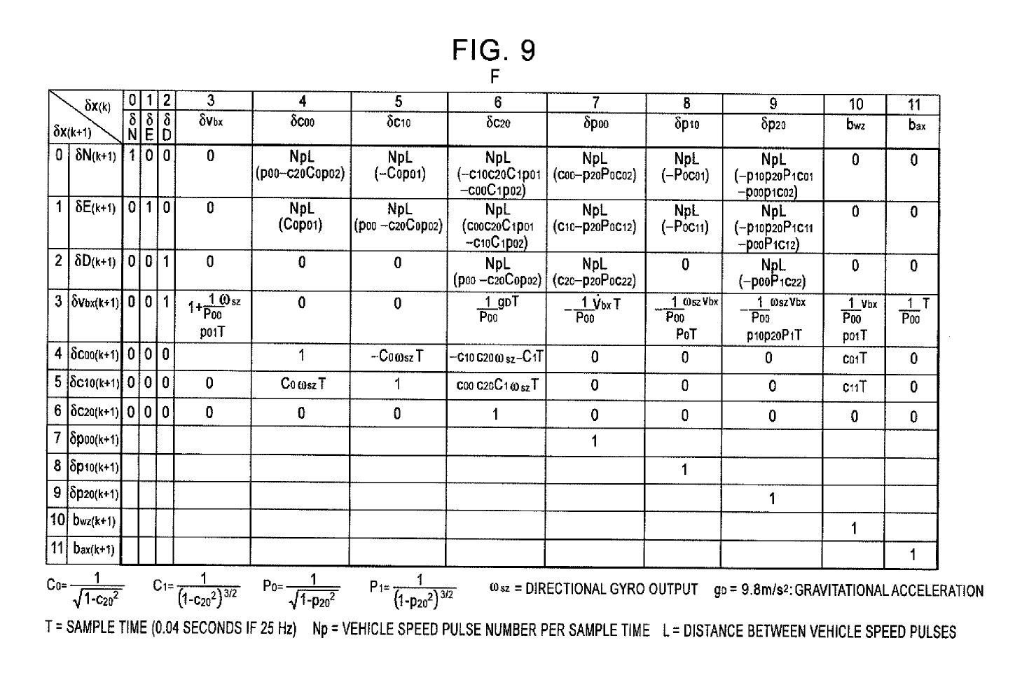

The system state variable δX is expressed as δX=[δN, δE, δD, δV_{bx}, δc₀₀, δc₁₀, δc₂₀, δp₀₀, δp₁₀, δp₂₀, b_{wz}, bₐₓ], wherein V_{bx}=Vsp (see equation (2)), b_{wz}=ω_{OF}, and bₐₓ=α_{OF} are established. Further, the parameters c₀₀ to P₂₀ constitute coordinate transformation matrix elements, and are expressed as c₀₀=cos θ cos Y, c₁₀=cos θ sin Y, C₂₀=−sin θ, p₀₀=cos A cos A2, p₁₀=cos A sin A2, and p₂₀=−sin A, respectively. The linear system F of the equation (7) can be expressed as the matrix illustrated in FIG. 9 on the basis of the equations representing the system model in equations (2), (3), and (5). The elements enclosed by the bold-lined box constitute the matrix elements. Further, cᵢⱼ and pᵢⱼ represent coordinate transformation matrix elements used in a transformation from a sensor coordinate system into an N-E-D coordinate system, and coordinate transformation matrix elements used in a transformation from the sensor coordinate system into a vehicle fixed coordinate system, respectively. The coordinate transformation matrix elements cᵢⱼ and pᵢⱼ are expressed by the following formulae, respectively.

$$[ \begin{matrix}{c}_{00} & {c}_{01} & {c}_{02} \\ {c}_{10} & {c}_{11} & {c}_{12} \\ {c}_{20} & {c}_{21} & {c}_{22}\end{matrix} ] = [ \begin{matrix}cos θcos Y & - sin Y & sin θ cos Y \\ cos θsin Y & cos Y & sin θsin Y \\ - sin θ & 0 & cos θ\end{matrix} ] \\ [ \begin{matrix}{p}_{00} & {p}_{01} & {p}_{02} \\ {p}_{10} & {p}_{11} & {p}_{12} \\ {p}_{20} & {p}_{21} & {p}_{22}\end{matrix} ] = [ \begin{matrix}cos A cos A 2 & - sin A 2 & sin A cos A 2 \\ cos A sin A 2 & cos A 2 & sin A sin A 2 \\ - sin A & 0 & cos A\end{matrix} ] \qquad Formula 1$$

Further, an observation equation of the Kalman filter according to the embodiment of the present invention is expressed as the following equation.

δZ(k)=H(k)δX(k)+v(k) (8)

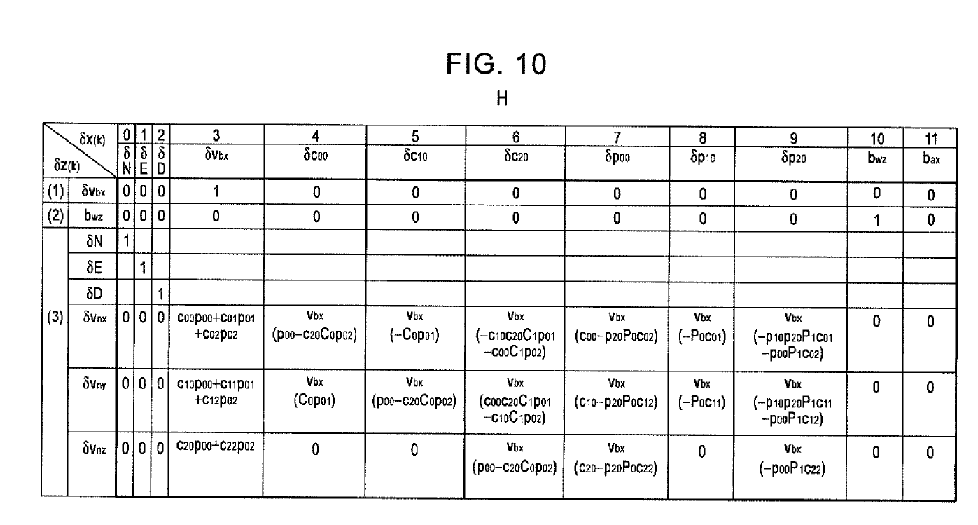

The observation matrix H of equation (8) is expressed as the matrix illustrated in FIG. 10. In FIG. 10, matrix portions (1), (2), and (3) of the observation matrix H constitute a portion used to calculate a speed error δV_{bx} in the cycle of 10 Hz, a portion used to calculate an angular speed signal offset error b_{wz} occurring in the stopped state of the vehicle in the cycle of 10 Hz, and a portion used to calculate vehicle position errors δN, δE, and δD and vehicle speed errors δvnx, δvny, and δvnz occurring in the GPS in the cycle of 1 Hz, respectively.

The matrix portion (1) of the observation matrix H constitutes the observation matrix H1 of the Kalman filter, which is used in the first correction process at the processing step S107 of FIG. 4. The observation matrix H1 is expressed as the following formula.

$$H 1 = \vert \begin{matrix}( 1 ) \\ 0 \\ 0\end{matrix} \vert \qquad Formula 2$$

Further, the matrix portions (1) and (3) of the observation matrix H constitute the observation matrix H2 of the Kalman filter, which is used in the second correction process at the processing step S108 of FIG. 4. The observation matrix H2 is expressed as the following formula.

$$H 2 = \vert \begin{matrix}( 1 ) \\ 0 \\ ( 3 )\end{matrix} \vert \qquad Formula 3$$

Further, the matrix portions (1) and (2) of the observation matrix H constitute the observation matrix H3 of the Kalman filter, which is used in the third correction process at the processing step S110 of FIG. 4. The observation matrix H3 is expressed as the following formula.

$$H 3 = \vert \begin{matrix}( 1 ) \\ ( 2 ) \\ 0\end{matrix} \vert \qquad Formula 4$$

Further, the matrix portions (1), (2), and (3) of the observation matrix H constitute the observation matrix H4 of the Kalman filter, which is used in the fourth correction process at the processing step S111 of FIG. 4. The observation matrix H4 is expressed as the following formula.

$$H 4 = \vert \begin{matrix}( 1 ) \\ ( 2 ) \\ ( 3 )\end{matrix} \vert \qquad Formula 5$$

The Kalman filter repeatedly performs the calculation of the following equation (9) on a predetermined cycle with the input of Z(t), i.e., δZ(t) to thereby obtain an optimal estimated value X(t|t), i.e., δX(t|t). The estimated value of A at a time i based on information obtained until a time j is represented as A(i|j).

X(t|t)=X(t|t−1)+K(t)[Z(t)−HX(t|t−1)] (9)

In the above equation, X(t|t−1) and K(t) represent a previously estimated value and a Kalman gain, respectively, and are expressed as X(t|t−1)=FX(t−1|t−1) and K(t)=P(t|t−1)H^{T}(HP(t|t−1)HT+V)⁻¹, respectively. Further, P, P(t|t−1), and P(t−1|t−1) represent the error covariance of a state quantity X, a predicted value of the error covariance at a time t based on information obtained until a time t−1, and the error covariance at the time t−1 respectively, and P(t|t−1) and P(t−1|t−1) are expressed as P(t|t−1)=FP(t−1|t−1)F^{T}+W and P(t−1|t−1)=(I−K(t−1)H)P(t−1|t−2), respectively. In the above, V and W represent the variance of noise v generated in the observation process 41 and the variance of noise w generated in the signal generation process 31, respectively. The superscripts ^{T} and ⁻¹ represent a transposed matrix and an inverse matrix, respectively. Further, I represents a unit matrix. Furthermore, V and W represent white Gaussian noises having an average of zero, and are uncorrelated to each other. In the Kalman filter as described above, initial values of the state quantity X and the error covariance P are provided with appropriate errors, and the calculation of the equation (7) is repeatedly performed every time a new measurement is performed. Accordingly, the accuracy of the state quantity X can be improved.

In the example described above, the Kalman filter is used to correct the respective parameters. However, what is used for the correction is not limited to the Kalman filter. Therefore, the correction can be performed by using a filtering system based on probability theory, such as an H-infinity filter and a particle filter.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed:

1. A position detecting device for detecting a current position of a vehicle, the position detecting device comprising:
a moving distance detection unit for measuring the moving distance of the vehicle;
an acceleration sensor for detecting the acceleration of the vehicle;
a relative direction sensor for outputting a signal in accordance with the amount of change in the direction of the vehicle,
a Global Positioning System receiver for receiving satellite radio waves from a Global Positioning System satellite and outputting information of a vehicle position and a vehicle speed in the latitudinal direction, the longitudinal direction, and the height direction;
a dead reckoning unit which, on a first cycle, calculates the vehicle position in the latitudinal direction, the longitudinal direction, and the height direction by using a pitch angle θ with respect to a horizontal surface and a yaw angle Y of the sensors for dead reckoning, a sensor installation pitch angle A and a sensor installation yaw angle A2 with respect to the vehicle, and the moving distance, and calculates the vehicle speed by using an acceleration signal output from the acceleration sensor;
a first correction unit which, on a second cycle longer than the first cycle, calculates the vehicle speed by using a signal output from the moving distance detection unit, and corrects, on the basis of the difference in speed between the thus calculated vehicle speed and the vehicle speed calculated by the dead reckoning unit, the vehicle speed, the pitch angle θ, the sensor installation pitch angle A, and the sensor installation yaw angle A2 calculated by the dead reckoning unit; and
a second correction unit which, on a third cycle longer than the second cycle, corrects the vehicle position in the latitudinal direction, the longitudinal direction, and the height direction, the vehicle speed, the pitch angle θ, the sensor installation pitch angle A, the yaw angle Y, the sensor installation yaw angle A2, an angular speed signal offset, and an acceleration signal offset calculated by the dead reckoning unit, by using the vehicle position and the vehicle speed in the latitudinal direction, the longitudinal direction, and the height direction output from the Global Positioning System receiver and the vehicle position and the vehicle speed in the latitudinal direction, the longitudinal direction, and the height direction output from the dead reckoning unit.

2. The position detecting device according to claim 1, further comprising:
an offset correction unit which, on the basis of the difference between an angular speed signal output from the relative direction sensor and the angular speed signal offset calculated by the dead reckoning unit, corrects the offset of the angular speed signal on the second cycle, when the vehicle is in a stopped state.

3. The position detecting device according to claim 1,
wherein the first correction unit corrects the angular speed signal offset and the acceleration signal offset in every correction of the vehicle speed calculated by the dead reckoning unit, and
wherein the dead reckoning unit calculates the vehicle position in the latitudinal direction, the longitudinal direction, and the height direction, the vehicle speed, the pitch angle θ, and the yaw angle Y by using a signal obtained by subtracting the acceleration signal offset from the acceleration signal output from the acceleration sensor as a true acceleration signal, and by using a signal obtained by subtracting the angular speed signal offset from the signal output from the relative direction sensor as a true angular speed signal.

4. The position detecting device according to claim 1,
wherein the moving distance detection unit constitutes a vehicle speed sensor for generating a pulse every time the vehicle moves by a predetermined distance, and
wherein the first correction unit calculates the vehicle speed by multiplying the number of pulses generated from the vehicle speed sensor during the second cycle by the predetermined distance and dividing the product by the second cycle.

5. The position detecting device according to claim 1,
wherein the moving distance detection unit constitutes a vehicle speed sensor for generating a pulse every time the vehicle moves by a predetermined distance, and
wherein the dead reckoning unit calculates the vehicle position in the latitudinal direction, the longitudinal direction, and the height direction by accumulating, on the vehicle position in the latitudinal direction, the longitudinal direction, and the height direction corrected by the first or second correction unit, a latitudinal component, a longitudinal component, and a height component of a moving distance obtained by multiplying the number of pulses generated from the vehicle speed sensor during the first cycle by the predetermined distance.

6. A position detecting method for detecting a current position of a vehicle, the position detecting method comprising:
a first step of, in a dead reckoning unit, and on a first cycle, calculating a vehicle position in the latitudinal direction, the longitudinal direction, and the height direction by using a pitch angle θ with respect to a horizontal surface and a yaw angle Y of dead reckoning sensors, which output signals in accordance with the acceleration of the vehicle and the amount of change in the direction of the vehicle, a sensor installation pitch angle A and a sensor installation yaw angle A2 with respect to the vehicle, and a moving distance of the vehicle detected by a moving distance detection unit, and calculating a vehicle speed by using an acceleration signal output from one of the sensors;
a second step of, on a second cycle longer than the first cycle, calculating the vehicle speed by using a signal output from the moving distance detection unit, and correcting, on the basis of the difference in speed between the thus calculated vehicle speed and the vehicle speed calculated by the dead reckoning unit, the vehicle speed, the pitch angle θ, the sensor installation pitch angle A, and the sensor installation yaw angle A2 calculated by the dead reckoning unit; and
a third step of, on a third cycle longer than the second cycle, correcting the vehicle position in the latitudinal direction, the longitudinal direction, and the height direction, the vehicle speed, the pitch angle θ, the sensor installation pitch angle A, the yaw angle Y, the sensor installation yaw angle A2, an angular speed signal offset, and an acceleration signal offset calculated by the dead reckoning unit, by using a vehicle position and a vehicle speed in the latitudinal direction, the longitudinal direction, and the height direction output from a Global Positioning System receiver and the vehicle position and the vehicle speed in the latitudinal direction, the longitudinal direction, and the height direction output from the dead reckoning unit.

7. The position detecting method according to claim 6, further comprising:
a step of, on the basis of the difference between an angular speed signal output from a relative direction sensor of the sensors and the angular speed signal offset calculated by the dead reckoning unit, correcting the offset of the angular speed signal on the second cycle, when the vehicle is in a stopped state.

8. The position detecting method according to claim 6, further comprising:
a step of correcting the angular speed signal offset and the acceleration signal offset in every correction of the vehicle speed in the dead reckoning unit; and
a step of, in the dead reckoning unit, calculating the vehicle position in the latitudinal direction, the longitudinal direction, and the height direction, the vehicle speed, the pitch angle θ, and the yaw angle Y by using a signal obtained by subtracting the acceleration signal offset from an acceleration signal output from an acceleration sensor of the sensors as a true acceleration signal, and by using a signal obtained by subtracting the angular speed signal offset from an angular speed signal output from a relative direction sensor of the sensors as a true angular speed signal.

9. The position detecting method according to claim 6,
wherein, when the moving distance detection unit constitutes a vehicle speed sensor for generating a pulse every time the vehicle moves by a predetermined distance, the vehicle speed is calculated in the second step by multiplying the number of pulses generated from the vehicle speed sensor during the second cycle by the predetermined distance and dividing the product by the second cycle.

10. The position detecting method according to claim 6,
wherein the moving distance detection unit constitutes a vehicle speed sensor for generating a pulse every time the vehicle moves by a predetermined distance, and
wherein the vehicle position in the latitudinal direction, the longitudinal direction, and the height direction is calculated in the first step by accumulating, on the vehicle position in the latitudinal direction, the longitudinal direction, and the height direction corrected by a first or second correction unit, a latitudinal component, a longitudinal component, and a height component of a moving distance calculated by multiplying the number of pulses generated from the vehicle speed sensor during the first cycle by the predetermined distance.
